(19) United States
(12) Patent Application Publication
(10) Pub. No.: US 2008/0043932 A1
(43) Pub. Date: Feb. 21, 2008

(54) METHOD OF TRANSMITTING EMERGENCY INFORMATION

(76) Inventors: Timothy J. Elliott, East Dubuque, IL (US); Candie A. Elliott, East Dubuque, IL (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/462,536

(22) Filed: Aug. 4, 2006

(51) Int. Cl. H04M 11/04

(52) U.S. Cl. 379/37

(57) ABSTRACT

A method of transmitting information to and from an emergency agency. The method involves transmitting emergency information from a personal computer to an internet provider that transmits an emergency condition signal to an emergency agency. Once the emergency agency receives the emergency condition signal the emergency agency transmits emergency information from the emergency agency to the personal computer to assist the individual faced with the emergency situation. Additionally, persons at the emergency agency are alerted of the emergency condition so that help may be dispatched to the individual in the emergency situation.

### BACKGROUND OF THE INVENTION

This application relates to a method of providing an emergency service. More particularly, this application relates to a method of providing and receiving emergency services via the internet.

Presently, when an emergency situation occurs such as a fire, crime, severe health condition, or the like one must find a telephone in order to dial 911 to receive emergency services. With the popularity of the internet many people no longer use a traditional phone line and use only their computer to provide them communications to others either via e-mail or by some type of camera phone. Unfortunately, for these individuals when faced with an emergency such as a fire in their house there is no method of contacting an emergency agency in order to receive emergency help similar to the help received by dialing 911 on a telephone. Thus, the person in the emergency situation must either e-mail with others on the internet of the emergency situation to have another individual phone in their emergency or they must leave the emergency situation to find the nearest phone which in many cases may be extremely dangerous, if not impossible.

As a solution to this problem, programs have been provided that can be downloaded on the computer that will dial an emergency service when needed. However, current programs do not take advantage of the capabilities of a personal computer nor do they provide adequate safety features that ensure any individual can use a computer in order to contact emergency services, yet minimize the amount of accidental calls tying up communication lines to emergency agencies.

Thus, it is a principal object of the present invention to provide a method of providing emergency service that provides information to an individual using the system.

Yet another object of the present invention is to provide a method of contacting emergency agencies that minimizes the amount of false calls.

These and other objects, features or advantages of the present invention will become apparent from the specification and claims.

### BRIEF SUMMARY OF THE INVENTION

A method of transmitting information to and from a service provider. This method involves inputting information into a personal computer regarding an emergency condition that the user is aware. The information is then inputted into a program within the personal computer and analyzed in order to transmit an emergency condition signal to an emergency agency. Once the emergency agency receives the emergency condition signal individuals at the agency are alerted of the emergency including location of the emergency and information the individual using the personal computer is able to transmit. Simultaneously, the emergency agency transmits emergency information back to the personal computer regarding the emergency condition in order to assist the individual that has contacted the emergency agency.

### BRIEF DESCRIPTION OF THE DRAWINGS

FIG. 1 is schematic diagram of an emergency system for transmitting emergency information from a personal computer to an emergency agency; and

FIG. 2 a block diagram of a method of transmitting information to and from a service provider using a personal computer.

### DETAILED DESCRIPTION OF THE PREFERRED EMBODIMENT

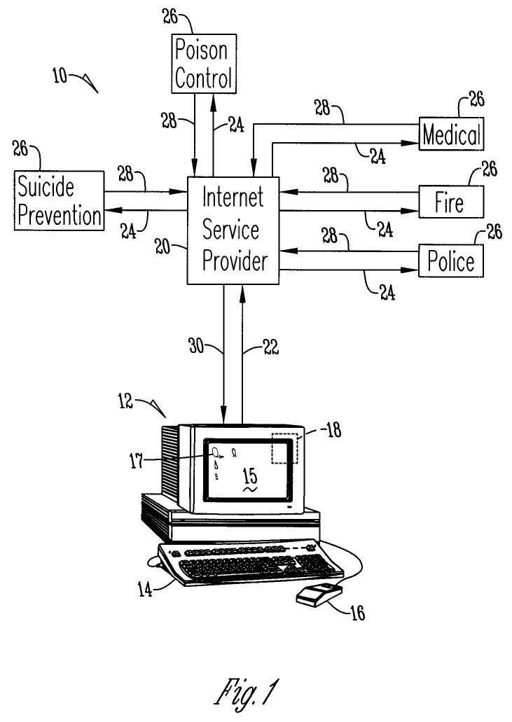

FIG. 1 shows an emergency system 10 that includes a personal computer 12 having a keyboard 14, screen 15 and a mouse 16. The screen 15 displays a plurality of icons including an emergency icon 17. Though shown with a mouse 16 the personal computer can be any type of computer such as a lap top computer, I-pod, or the like but has enough memory to have a program 18 downloaded therein that is able to communicate with an internet service provider 20.

The internet service provider 20 then communicates with the program 18 such that information can be inputted into the program either via the keyboard 14, mouse 16 or the like regarding an emergency condition. The program 18 is able to analyze the information and provide emergency information to a user regarding the emergency condition. The program additionally sends an output 22 to the internet service provider 20 to transmit an emergency signal 24 to an emergency agency 26. FIG. 1 shows a plurality of emergency agencies that include, but are not limited to, a police station, a fire station, a medical facility or hospital, a poison controller center, a suicide prevention center, or the like.

Once the emergency agency 26 receives the emergency condition signal 24 from the internet service provider 20, individuals at the emergency agency 26 are alerted of the emergency condition. Simultaneously, additional emergency information is transmitted to the internet service provider 20 via an emergency information signal 28 to provide an emergency input 30 back to the personal computer 12. Thus, an individual using the personal computer 12 may be assisted by use of the additional emergency information. For example only, the emergency agency 26 can transmit their estimated time of arrival.

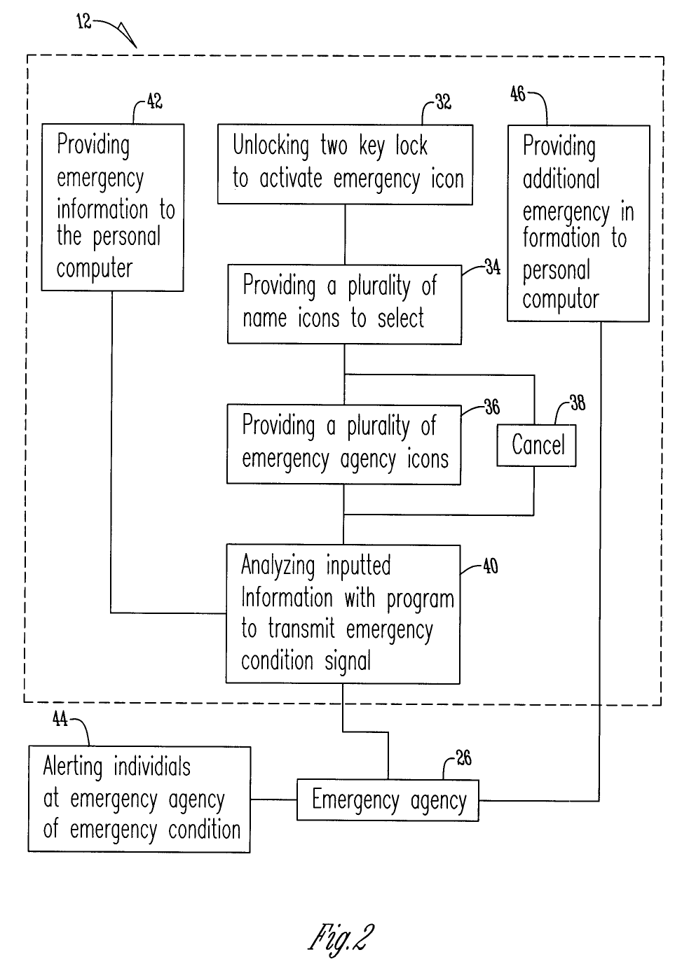

Thus, in operation, when an emergency condition occurs the method of transmitting this information is best seen in FIG. 2. Once the emergency situation has occurred the first step is for an individual to input information into a person computer regarding the emergency condition.

In a preferred embodiment the first step is accomplished by unlocking a two-key lock system to activate an emergency icon 17 on the screen of the computer 12 as provided in box 32. A two key lock system requires the simultaneous actuation of two keys on the keyboard 14. Once both keys are actuated simultaneously an individual then has a predetermined amount of time to actuate, or click on, an emergency icon 17 that is on the computer screen 15. By having a two key lock, children are prevented from accidentally actuating the emergency icon 17 causing a false emergency call. Similarly, by setting a predetermined time period after the two key lock is unlocked, the chances of a child, or individual accidentally unlocking the two key lock by pounding on the keyboard, followed by actuating the emergency icon 17 by clicking on the icon is minimized. Additionally, by having a universal two keys, any individual could unlock any computer using the same two key unlocking system to contact emergency services. Thus multiple passwords or the like do not have to be remembered by individuals during an emergency situation in order to contact an emergency agency 26.

After the two key lock is unlocked and the emergency icon 17 is actuated, another set of icons such as the names of family members and anyone else residing at the home is provided on the screen of the computer 12 as provided in box 34. Each person has their own separate assigned icon with his/her name thereon and a there own color of their choice. The color provides an additional form of identification for children in an emergency. Also, the icons can be arranged from eldest to the youngest.

Next, when the icon of the person needing help is actuated, or clicked on, the icon itself automatically changes to the service needed such as police, fire or the like. Furthermore, animated people and vehicles such as a police car, fire truck, ambulance or agency symbol can be used to represent the different emergency agencies 26. Once an emergency service such as the police are chosen as shown in box 36 by clicking on the police icon, after three seconds a call is sent or a message appears on the screen advising that the call went out thus giving a chance to cancel the call. Thus, if the incorrect choice is made an individual may simply cancel the choice before the emergency call is provided as shown in box 38. This process allows an individual to contact an emergency service within seconds while providing an abundance of information regarding the emergency.

Additionally, a neutral icon can be used if an individual needs to summon help in case of emergency other than a residence. Thus, information is to be provided regarding locations other than your home, and individuals other than individuals previously inputted into the program 18. This may be especially useful when using a lap top or other electronic mobile device.

The next step as seen in box 40 is for the computer program 18 to analyze the information inputted by the individual, to transmit an emergency condition signal 24 to an emergency agency 26. The program 18 is capable of storing a vast amount of data, or information, which in a preferred embodiment consists of many different types of information stored on the computer such as, for example only, the type of emergency, the address and location of the emergency accompanied by global positioning satellite (GPS) information, a list of all occupants residing in a household (if applicable) with full photo identification and the like. This information is provided to the emergency agency 26 via the emergency information signal 28.

For medical emergencies requiring an ambulance and medical personnel/paramedics, the program 18 in a preferred embodiment automatically provides further immediate medical information of any individual whose identity and personal medical information has been entered into the computer 12 through the program 18. This includes identification of the individual, along with a photo and physical description, sex, nationality, medical records, medical conditions, medications, physical disabilities, mental health, mental disabilities and the like. Additionally, provided would be a list of all phone numbers to the home including extensive lists of cell phone numbers of other occupants, immediate family, close friends and neighbors that may need to be contacted.

Another advantage of the system 10 is that even if a person should lose consciousness or have to leave the premises immediately, as long as information was sent, all the information would still be available for the responding emergency personnel. The program 18 also provides emergency information, non-emergency information, and/or instructions to assist an individual in the emergency situation as provided in box 42. Specifically the program 18 opens a separate window or windows with the information and/or instructions needed. Such instructions may include how to perform CPR, the Heimlich maneuver, instructions on what one should do in case of a fire or tornado, or the like. Any and all information and/or instructions can be printed out on paper for use away from the computer and is accessible through cellular phones that are internet compatible.

Once the emergency agency 26 receives the emergency condition signal, the emergency condition signal alerts individuals at the emergency agency 26 of the emergency condition and additionally transmits additional emergency information from the emergency agency 26 to the personal computer 12 regarding the emergency condition to assist the individual who provided the original information as best shown in boxes 44 and 46. This information can include the estimated time of arrival of the emergency services.

Therefore, a method is provided that allows an individual to not only provide information regarding an emergency situation using a personal computer over the internet but additionally allows the transmittal of emergency information that may be used to assist the individual with handling the situation. The method allows an individual to summons any and all agencies of emergency help and rescue through local internet service providers in each geographical area with direct connections to local police, fire, medical and the like. In addition, the system 10 contains information that is readily used by the emergency personnel. The program is implemented many different ways in many different computers, but no matter the configuration, the end result remains the same of the initial call summoning the correct emergency agency and providing all imperative information associated with the type of emergency being reported.

Thus, a permanent desktop icon on the computer screen can be used in order to represent all emergency agencies including police, fire, ambulance, animal control, poison hotline, suicide prevention hotline (providing live chat or toll free numbers), emergency weather services with local and regional Doppler radar and satellite, and the like. Additionally the method allows for separate windows to open on the computer screen with emergency information and/or instructions on what to do, even simple tips or reminders of dos and don'ts that one should follow in any given situation. Thus, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A method of transmitting information to and from an emergency agency steps comprising:
inputting information into a personal computer regarding an emergency condition;
analyzing the information with a program to transmit an emergency information signal to an emergency agency; and
providing emergency information on the personal computer regarding the emergency condition.

2. The method of claim 1 wherein the emergency agency is a police department.

3. The method of claim 1 wherein the emergency agency is a fire station.

4. The method of claim 1 wherein the emergency agency is a hospital.

5. The method of claim 1 further comprising the step of: unlocking a two key lock to activate an icon on a computer screen for a predetermined period of time.

6. The method of claim 5 wherein the information is inputted into the personal computer by actuating the icon on the computer screen after the two key lock is unlocked.

7. The method of claim 1 wherein the emergency information includes directions regarding how to perform CPR.

8. The method of claim 1 wherein the computer program has global positioning satellite information that is transmitted within the emergency information signal.

9. The method of claim 1 further comprising the step of: transmitting additional emergency information from the emergency agency to the personal computer.

10. The method of claim 9 wherein the additional emergency information includes an estimated time of arrival of emergency help.
